(19) United States
(12) Patent Application Publication
(10) Pub. No.: US 2025/0264666 A1
(43) Pub. Date: Aug. 21, 2025

(54) OPTICAL MODULE

(71) Applicant: SHINKO ELECTRIC INDUSTRIES CO., LTD., Nagano-shi (JP)

(72) Inventors: Yuji FURUTA, Nagano-shi (JP); Hisashi KANEDA, Nagano-shi (JP)

(21) Appl. No.: 19/049,175

(22) Filed: Feb. 10, 2025

(30) Foreign Application Priority Data
Feb. 15, 2024 (JP) 2024-021161

(51) Int. Cl. G02B 6/36

(52) U.S. Cl. CPC G02B 6/3608

(57) ABSTRACT

An optical module includes a wiring substrate and an optical waveguide device mounted on the wiring substrate. The wiring substrate includes a core substrate, a wiring structure formed on an upper surface of the core substrate, and a notch extending through the wiring structure in a thickness direction and exposing a peripheral portion of the core substrate. The optical waveguide device is mounted on an upper surface of the wiring structure at a position proximate to the notch.

### CROSS-REFERENCE TO RELATED APPLICATIONS

This application is based upon and claims the benefit of priority from prior Japanese Patent Application No. 2024-021161, filed on Feb. 15, 2024, the entire contents of which are incorporated herein by reference.

### BACKGROUND

### 1. Field

This disclosure relates to an optical module and a method for manufacturing an optical module.

### 2. Description of Related Art

A known optical module used for optical communication includes a wiring substrate, an optical waveguide device mounted on the wiring substrate, and an optical component coupled to the waveguide device (refer to Japanese Laid-Open Patent Publication No. 2020-64211). The optical waveguide device may be, for example, a planar lightwave circuit, an optical fiber array, or the like.

### SUMMARY

In the above described optical module, it is desirable that the coupling reliability of the optical waveguide device and the optical component be improved.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical module includes a wiring substrate and an optical waveguide device mounted on the wiring substrate. The wiring substrate includes a core substrate, a wiring structure located on an upper surface of the core substrate, and a notch extending through the wiring structure in a thickness direction and exposing a peripheral portion of the core substrate. The optical waveguide device is mounted on an upper surface of the wiring structure at a position proximate to the notch.

Other features and aspects will be apparent from the following detailed description, the drawings, and the claims.

### BRIEF DESCRIPTION OF THE DRAWINGS

FIG. 1 is a schematic cross-sectional view of an optical module in accordance with one embodiment (cross-sectional view taken along line 1-1 in FIG. 2).

FIG. 2 is a schematic plan view of part of the optical module illustrated in FIG. 1.

FIGS. 3, 4, 5, and 6 are schematic cross-sectional views illustrating a method for manufacturing the wiring substrate of FIG. 1.

FIG. 7 is a schematic cross-sectional view illustrating a modified optical module.

FIG. 8 is a schematic cross-sectional view illustrating another modified optical module.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

One embodiment will now be described with reference to the drawings.

In the accompanying drawings, elements are illustrated for simplicity and clarity and have not necessarily been drawn to scale. In the cross-sectional views, to facilitate understanding of the cross-sectional structure of each member, hatching lines may be replaced by shadings or may not be illustrated. In the plan views, to facilitate understanding of the planar shapes of each member, hatching lines may be added to some of the members. Each drawing indicates an X-axis, a Y-axis, and a Z-axis, which are orthogonal to each other. The drawings indicate a first direction X1 that extends toward one side along the X-axis, and a first opposite direction X2 that extends opposite the first direction X1. Further, the drawings indicate a second direction Y1 that extends toward one side along the Y-axis, and a second opposite direction Y2 that extends opposite the second direction Y1. Further, the drawings indicate a third direction Z1 that extends toward one side along the Z-axis, and a third opposite direction Z2 that extends opposite the third direction Z1. In this specification, “plan view” refers to a view of a subject taken in the Z-axis direction unless otherwise specified. Further, in this specification, “planar shape” refers to a shape of a subject as viewed in the Z-axis direction unless otherwise specified. Also, in this specification, the term “face” is used to indicate that surfaces or members are arranged in front of each other. In this case, the surfaces or members do not have to be entirely in front of each other and may be partially in front of each other. Moreover, in this specification, the term “face” will also be used to describe situations including a case in which two members are separated from each other in addition to a case in which two members are in contact with each other. Further, unless otherwise specified, a numerical range of “X1 to X2,” which is specified by upper limit value X1 and lower limit value X2, refers to a range that is greater than or equal to X1 and less than or equal to X2.

### Overall Structure of Optical Module 10

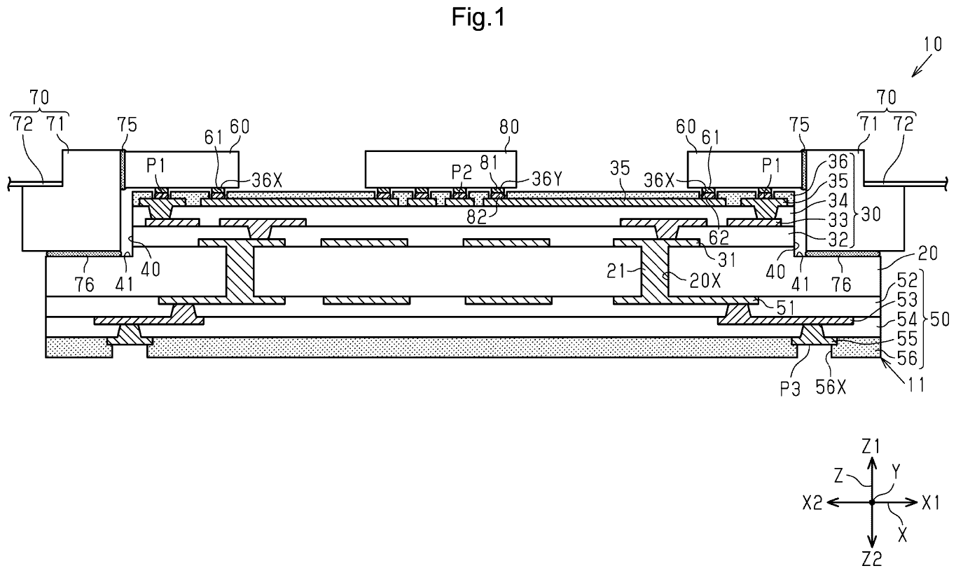

As illustrated in FIG. 1, an optical module 10 includes a wiring substrate 11 and one or more (two in the present embodiment) optical waveguide devices 60 mounted on the wiring substrate 11. The optical module 10 further includes, for example, one or more (two in the present embodiment) optical fiber arrays 70 mounted on the wiring substrate 11, and at least one (one in the present embodiment) electronic component 80 mounted on the wiring substrate 11. Each optical fiber array 70 is an example of an optical component.

### Structure of Wiring Substrate 11

The wiring substrate 11 includes a core substrate 20, a wiring structure 30 located on an upper surface of the core substrate 20, and a wiring structure 50 located on the lower surface of the core substrate 20. The wiring structure 30 is formed by sequentially stacking a wiring layer 31, an insulation layer 32, a wiring layer 33, an insulation layer 34, a wiring layer 35, and a solder resist layer 36 on the upper surface of the core substrate 20. The wiring structure 50 is formed by sequentially stacking a wiring layer 51, an insulation layer 52, a wiring layer 53, an insulation layer 54, a wiring layer 55, and a solder resist layer 56 on the lower surface of the core substrate 20.

The wiring layers 31, 33, 35, 51, 53, and 55 may be formed from, for example, copper or a copper alloy. The wiring layers 31, 33, 35, 51, 53, and 55 may each have a coefficient of thermal expansion (CTE) of, for example, approximately 15 ppm/° C. to 18 ppm/° C. Further, the wiring layers 31, 33, 35, 51, 53, and 55 may each have a thickness of, for example, approximately 5 μm to 20 μm.

The insulation layers 32, 34, 52, and 54 may be formed from, for example, an insulative thermosetting resin. The insulative thermosetting resin may be an insulative resin such as an epoxy resin, a polyimide resin, or a cyanate resin. The insulation layers 32, 34, 52, and 54 may contain, for example, a filler of silica or alumina. The insulation layers 32, 34, 52, and 54 may each have a coefficient of thermal expansion of, for example, approximately 20 ppm/° C. to 40 ppm/° C. The insulation layers 32, 34, 52, and 54 may each have a thickness of, for example, approximately 10 μm to 30 μm.

The solder resist layers 36 and 56 may be formed from, for example, an insulative resin of which the main component is a photosensitive resin such as a phenolic resin or a polyimide resin. the solder resist layers 36 and 56 may contain, for example, a filler of silica or alumina. The solder resist layers 36 and 56 may each have a coefficient of thermal expansion of, for example, approximately 20 ppm/° C. to 40 ppm/° C. The solder resist layers 36 and 56 may each have a thickness of, for example, approximately 10 μm to 30 μm.

### Structure of Core Substrate 20

The core substrate 20 is arranged in, for example, the middle part of the wiring substrate 11 in the thickness direction. The core substrate 20 has the form of, for example, a flat plate. The core substrate 20 may have any planar shape. The core substrate 20 may have, for example, a rectangular planar shape.

The core substrate 20 is an insulation layer having higher rigidity than the insulation layers 32 and 34 of the wiring structure 30. The core substrate 20 is, for example, thicker than the insulation layers 32 and 34. The core substrate 20 may have a thickness of, for example, approximately 50 μm to 500 μm. Preferably, the core substrate 20 is formed from a material having a coefficient of thermal expansion similar to that of the optical waveguide devices 60 and the optical fiber arrays 70. The material of the core substrate 20 may be, for example, glass, silicon, or the like. The core substrate 20 is configured by, for example, a single layer. That is, the core substrate 20 is a single member.

The core substrate 20 has, for example, approximately the same coefficient of thermal expansion as the optical waveguide devices 60. The core substrate 20 has, for example, approximately the same coefficient of thermal expansion as the optical fiber arrays 70. In the present specification, “approximately the same” in the phrase of “approximately the same coefficient of thermal expansion” refers to a range in which the difference in the coefficient of thermal expansion between the core substrate 20 and the optical waveguide devices 60 or the optical fiber arrays 70 is within a range of 10 ppm/° C. or less. The coefficient of thermal expansion of the optical waveguide devices 60 may be, for example, approximately 3 ppm/° C. to 6 ppm/° C. The coefficient of thermal expansion of the optical fiber arrays 70 may be, for example, approximately 3 ppm/° C. to 6 ppm/° C. The coefficient of thermal expansion of the core substrate 20 may be, for example, approximately 3 ppm/° C. to 12 ppm/° C.

The difference in the coefficient of thermal expansion between the core substrate 20 and the optical waveguide devices 60 is, for example, less than the difference in the coefficient of thermal expansion between the wiring structure 30 and the optical waveguide devices 60. In the example of FIG. 1, the difference in the coefficient of thermal expansion between the core substrate 20 and the optical waveguide devices 60 is, for example, less than the difference in the coefficient of thermal expansion between wiring layers 31, 33, and 35 of the wiring structure 30 and the optical waveguide devices 60. Further, the difference in the coefficient of thermal expansion between the core substrate 20 and the optical waveguide devices 60 is, for example, less than the difference in the coefficient of thermal expansion between the insulation layers 32 and 34 of the wiring structure 30 and the optical waveguide devices 60. The difference in the coefficient of thermal expansion between the core substrate 20 and the optical waveguide devices 60 is, for example, less than the difference in the coefficient of thermal expansion between the solder resist layer 36 of the wiring structure 30 and the optical waveguide devices 60.

The difference in the coefficient of thermal expansion between the core substrate 20 and the optical fiber arrays 70 is, for example, less than the difference in the coefficient of thermal expansion between the wiring structure 30 and the optical fiber arrays 70. In the example of FIG. 1, the difference in the coefficient of thermal expansion between the core substrate 20 and the optical fiber arrays 70 is, for example, less than the difference in the coefficient of thermal expansion between the wiring layers 31, 33, and 35 and the optical fiber arrays 70. Further, the difference in the coefficient of thermal expansion between the core substrate 20 and the optical fiber arrays 70 is, for example, less than the difference in the coefficient of thermal expansion between the insulation layers 32 and 34 and the optical fiber arrays 70. The difference in the coefficient of thermal expansion between the core substrate 20 and the optical fiber arrays 70 is, for example, less than the difference in the coefficient of thermal expansion between the solder resist layer 36 and the optical fiber arrays 70.

The core substrate 20 includes through holes 20X extending through the core substrate 20 in the thickness direction. A through-electrode 21 extending through the core substrate 20 in the thickness direction is arranged in each through hole 20X.

### Wiring Structure 30

The wiring layer 31 is formed on the upper surface of the core substrate 20. The wiring layer 31 is electrically connected by the through-electrodes 21 to the wiring layer 51. The insulation layer 32, which covers the wiring layer 31, is located on the upper surface of the core substrate 20. The wiring layer 33 is located on the upper surface of the insulation layer 32. The wiring layer 33 is, for example, formed integrally with via wiring extending through the insulation layer 32 in the thickness direction, and is electrically connected by the via wiring to the wiring layer 31. The insulation layer 34, which covers the wiring layer 33, is located on the upper surface of the insulation layer 32. The wiring layer 35 is located on the upper surface of the insulation layer 34. The wiring layer 35 is, for example, formed integrally with via wiring extending through the insulation layer 34 in the thickness direction, and is electrically connected by the via wiring to the wiring layer 33. The wiring layer 35 includes, for example, wiring electrically connecting the electronic component 80 and the optical waveguide devices 60 to one another. The solder resist layer 36, which covers the wiring layer 35, is located on the upper surface of the insulation layer 34. The solder resist layer 36 is the outermost insulation layer (in this case, uppermost insulation layer) of the wiring substrate 11.

The solder resist layer 36 includes openings 36X exposing parts of the upper surface of the wiring layer 35 as connection pads P1. Further, the solder resist layer 36 includes openings 36Y exposing parts of the upper surface of the wiring layer 35 as connection pads P2. The connection pads P1 are, for example, connected to the optical waveguide devices 60. The connection pads P2 are, for example, connected to the electronic component 80.

A surface-processed layer is formed, if necessary, on the upper surface of the wiring layer 35 exposed at the bottom of each of the openings 36X and 36Y. Examples of the surface-processed layer includes a gold (Au) layer, a nickel (Ni) layer/Au layer (metal layer in which Ni layer serves as bottom layer, and Au layer is formed on Ni layer), a Ni layer/palladium (Pd) layer/Au layer (metal layer in which Ni layer serves as bottom layer, Ni layer, Pd layer, and Au layer are sequentially formed in this order). Further examples of the surface-processed layer include a Ni layer/Pd layer (metal layer in which Ni layer is bottom layer, and Pd layer is formed on Ni layer) and a Pd layer/Au layer (metal layer in which the Pd layer is bottom layer, and/Au layer is formed on the Pd layer). An Au layer is a metal layer formed from Au or an Au alloy, a Ni layer is a metal layer formed from Ni or a Ni alloy, and a Pd layer is a metal layer formed from Pd or a Pd alloy. An Au layer, a Ni layer, and a Pd layer may each be, for example, a metal layer formed through an electroless plating process (electroless plating layer) or a metal layer formed through an electrolytic plating process (electrolytic plating layer). Further, the surface-processed layer may be an organic solderability preservative (OSP) film formed on the upper surface of the wiring layer 35 through an anti-oxidation process such as an OSP process. The OSP film may be, for example, an organic coating of an azole compound or an imidazole compound. When the surface-processed layer is formed on the upper surface of the wiring layer 35, the surface-processed layer acts as the connection pads P1 and P2.

### Wiring Structure 50

The wiring layer 51 is formed on the lower surface of the core substrate 20. The wiring layer 51 is electrically connected by the through-electrodes 21 to the wiring layer 31. The insulation layer 52, which covers the wiring layer 51, is located on the lower surface of the core substrate 20. The wiring layer 53 is located on the lower surface of the insulation layer 52. The wiring layer 53 is, for example, formed integrally with via wiring extending through the insulation layer 52 in the thickness direction, and is electrically connected by the via wiring to the wiring layer 51. The insulation layer 54, which covers the wiring layer 53, is located on the lower surface of the insulation layer 52. The wiring layer 55 is located on the lower surface of the insulation layer 54. The wiring layer 55 is, for example, formed integrally with via wiring extending through the insulation layer 54 in the thickness direction, and is electrically connected by the via wiring to the wiring layer 53. The solder resist layer 56, which covers the wiring layer 55, is located on the lower surface of the insulation layer 54. The solder resist layer 56 is the outermost insulation layer (in this case, lowermost insulation layer) of the wiring substrate 11.

The solder resist layer 56 includes openings 56X exposing parts of the lower surface of the wiring layer 55 as external connection pads P3. The external connection pads P3 are connected to external connection terminals (not illustrated) used when mounting the optical module 10 on a mounting substrate such as a motherboard.

A surface-processed layer is formed, if necessary, on the lower surface of the wiring layer 55 exposed at the bottom of each of the openings 56X. Examples of the surface-processed layer include an OSP film or a metal layer such as a Au layer, a Ni layer/Au layer, a Ni layer/Pd layer/Au layer, a Ni layer/Pd layer, or a Pd layer/Au layer.

In the present example, external connection terminals (not illustrated) are arranged on the lower surface of the wiring layer 55. Instead, the wiring layer 55 exposed at the bottom of each opening 56X may be used as the external connection terminals. Alternatively, when a surface-processed layer is formed on the lower surface of the wiring layer 55, the surface-processed layer may be used as the external connection terminals.

The wiring substrate 11 includes one or more notches 40. The wiring substrate 11 of the present embodiment includes two notches 40. In FIG. 1, the wiring substrate 11 includes two notches 40 respectively corresponding to the two optical fiber arrays 70. Since the two notches 40 are identical in structure, the description hereafter will focus on the notch 40 located in the end of the wiring substrate 11 in the first direction X1 (right side as viewed in FIG. 1). Thus, the description will also apply to the other notch 40 located at the opposite side.

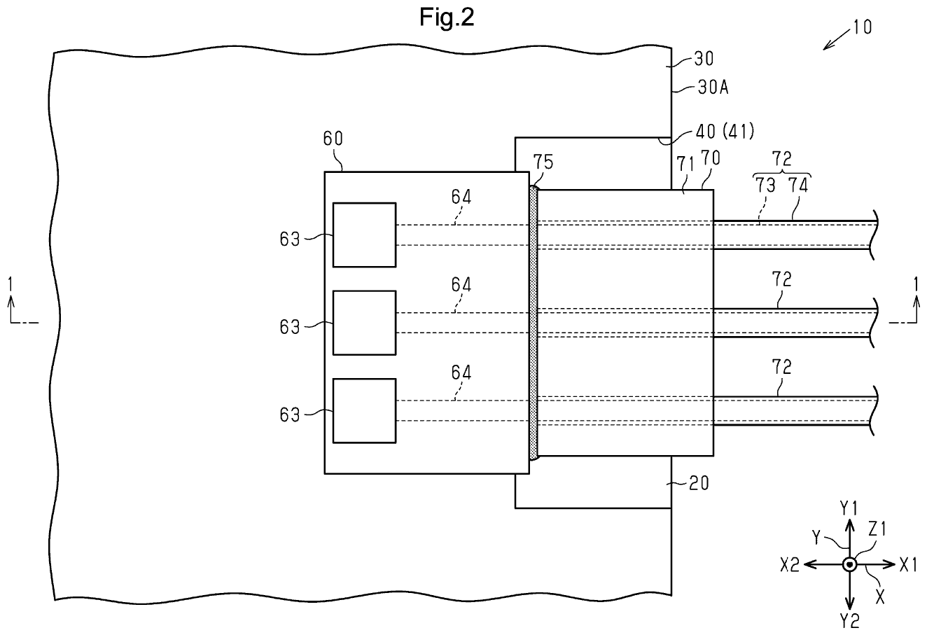

The notch 40 extends through the wiring structure 30 in the thickness direction and exposes the peripheral portion of the core substrate 20. The notches 40 exposes, for example, part of the peripheral portion of the core substrate 20. As illustrated in FIG. 2, the notch 40 is sized to receive the corresponding optical fiber array 70 on the part of the peripheral portion of the core substrate 20. The notch 40 extends through the solder resist layer 36 in the thickness direction, and extends through the insulation layers 32 and 34 in the thickness direction.

With reference to FIG. 2, the end surface 30A of the wiring structure 30 in the first direction X1 is cut out in the first opposite direction X2 to form the notch 40. Thus, the notch 40 is indented from the end surface 30A in the first opposite direction X2. As illustrated in FIG. 1, the notch 40 is open in the first direction X1 and in the third direction Z1. As illustrated in FIG. 2, the notch 40 has, for example, a rectangular planar shape. The notch 40 is not limited to a rectangular planar shape and may have any planar shape. The notch 40 extends from the end surface 30A in the first opposite direction X2 and in the second direction Y1. The notch 40 extends, for example, over only part of the wiring structure 30 in the second direction Y1. The notch 40 extends, for example, over an intermediate portion of the wiring structure 30 in the second direction Y1.

The notch 40 is smaller in dimension in the second direction Y1 than the wiring structure 30. The notch 40 is larger in dimension in the second direction Y1 than the corresponding optical waveguide device 60. The notch 40 is larger in dimension in the second direction Y1 than the corresponding optical fiber array 70.

As illustrated in FIG. 1, the inner end surface of the notch 40, that is, the end surface of the notch 40 in the first opposite direction X2, is defined by, for example, the end surface of the insulation layer 32, the end surface of the insulation layer 34, and the end surface of the solder resist layer 36. In one example, the end surface of the insulation layer 32, the end surface of the insulation layer 34, and the end surface of the solder resist layer 36, which define the inner end surface of the notch 40, are flush with one another.

The upper surface of the core substrate 20 exposed by the notch 40 includes, for example, a recess 41. The recess 41 is recessed from the upper surface of the core substrate 20 toward the wiring structure 50 (i.e., in third opposite direction Z2). The recess 41 does not extend through the core substrate 20 in the thickness direction. The recess 41 has a bottom surface located at an intermediate position of the core substrate 20 in the thickness direction. In other words, the core substrate 20 includes a thin portion that is reduced in thickness by the recess 41 so that an upper surface of the thin portion defines the bottom surface of the recess 41. This defines a thin portion having an upper surface corresponding to the bottom surface of the recess 41. The recess 41 is, for example, in communication with the notch 40. The recess 41 is formed in, for example, the entire part of the upper surface of the core substrate 20 that is exposed by the notch 40. In this case, the recess 41 and the notch 40 are identical in planar shape. Further, the recess 41 and the notch 40 have the same planar size.

The optical waveguide devices 60, the optical fiber arrays 70, and the electronic component 80 are mounted on the wiring substrate 11. Optical functional elements other than the optical waveguide devices 60 and the optical fiber arrays 70 may be mounted on the wiring substrate 11. Examples of optical functional elements include an optical modulator, an optical amplifier, and an optical attenuator.

### Structure of Optical Waveguide Device 60

Each optical waveguide device 60 includes electrode pads 61 formed on one surface (in this case, lower surface) of the optical waveguide device 60. The optical waveguide device 60 is mounted on the upper surface of the wiring substrate 11. The optical waveguide device 60 is, for example, flip-chip mounted on the upper surface of the wiring structure 30 of the wiring substrate 11. The electrode pads 61 of the optical waveguide device 60 are electrically connected by a bonding member 62 to the connection pads P1 of the wiring substrate 11. Thus, the optical waveguide device 60 is electrically connected by the electrode pads 61 and the bonding member 62 to the wiring layer 35 of the wiring substrate 11.

The electrode pads 61 respectively face the connection pads P1. Each electrode pad 61 is, for example, cylindrical and projects downward from the lower surface of the optical waveguide device 60. Each electrode pad 61 is, for example, a metal post. The electrode pads 61 may be formed from, for example, copper or a copper alloy.

The bonding member 62 may include, for example, gold bumps or solder bumps. The material of the solder bumps may be, for example, an alloy including lead (Pb), an alloy of tin (Sn) and Au, an alloy of Sn and Cu, an alloy of Sn and silver (Ag), or an alloy of Sn, Ag, and Cu.

Since the two optical waveguide devices 60 are identical in structure, the description hereafter will focus on the optical waveguide device 60 located on the end of the wiring substrate 11 in the first direction X1 (right side as viewed in FIG. 1). Thus, the description will also apply to the other optical waveguide device 60 located at the opposite side.

As illustrated in FIG. 2, the optical waveguide device 60 includes, for example, one or more (three in the present embodiment) optical elements 63 and one or more (three in the present embodiment) optical waveguides 64. The optical waveguide device 60 is, for example, a silicon photonics component. Each optical waveguide 64 is, for example, a silicon optical waveguide.

Each optical element 63 may be, for example, a light emitting element, for example, a surface emitting semiconductor laser, such as a vertical cavity surface emitting laser (VCSEL), or a light emitting diode (LED). The optical element 63 may also be, for example, a light receiving element such as a photodiode or an avalanche photodiode.

The optical waveguides 64 are, for example, respectively coupled (optically coupled) to the optical elements 63. The optical waveguides 64, for example, couple the optical elements 63 to the optical fiber array 70. The optical waveguides 64 are, for example, elongated in the first direction X1. The end of each optical waveguide 64 in the first direction X1 is optically coupled to the optical fiber array 70, and the end of each optical waveguide 64 in the first opposite direction X2 is optically coupled to the corresponding optical element 63. Each optical waveguide 64 extends, for example, from the corresponding optical element 63 to the end surface of the optical waveguide device 60 in the first direction X1. The optical waveguides 64 are arranged, for example, next to one another in the second direction Y1. Although not illustrated in the drawings, each optical waveguide 64 includes, for example, a core, which transmits optical signals, and cladding, which surrounds the core.

The optical waveguide device 60 is located proximate to the notch 40. The optical waveguide device 60 is mounted on the upper surface of the wiring structure 30 at a position proximate to the notch 40. As illustrated in FIG. 1, the notch 40 defines a step between the upper surface of the wiring structure 30 and the upper surface of the core substrate 20. The optical waveguide device 60 is mounted on the upper surface of the wiring structure 30 so that a part of the optical waveguide device 60 projects beyond a wall of the step into the notch 40 in plan view. The optical waveguide device 60 is arranged, for example, so that the end of the optical waveguide device 60 in the first direction X1 overlaps the notch 40 in plan view. The end of the optical waveguide device 60 in the first direction X1 projects in the first direction X1 from the inner end surface of the notch 40 (wall of step), namely, the end surface of the notch 40 in the first opposite direction X2.

### Structure of Optical Fiber Array 70

Each optical fiber array 70 includes a housing 71 and one or more (three in the present embodiment) optical fibers 72. The housing 71 holds three optical fibers 72. The housing 71 holds the three optical fibers 72, for example, in a state arranged next to one another in the second direction Y1.

Each optical fiber 72 includes, for example, a core 73, which transmits optical signals, and cladding 74, which surrounds the core 73. The core 73 extends, for example, over the entire length of the optical fiber 72 in the longitudinal direction of the optical fiber 72. The cladding 74 extends, for example, over the entire length of the optical fiber 72 in the longitudinal direction. The end of each optical fiber 72 in the first opposite direction X2 is, for example, located at the same position as the end surface of the housing 71 in the first opposite direction X2. Each optical fiber 72 extends, for example, further in the first direction X1 from the end of the housing 71 in the first direction X1.

The optical fiber array 70 faces the end surface of the optical waveguide devices 60 in the first direction X1. The optical fiber array 70 is arranged, for example, so that the end surface of each optical fiber 72 in the first opposite direction X2 faces the end surface of the corresponding optical waveguide 64 in the first direction X1. The optical fiber array 70 is arranged so that the center axis of the core 73 in each optical fiber 72 is aligned with the center axis of the core in the corresponding optical waveguide 64. Namely, the optical fiber array 70 is arranged so that the optical axis of the core 73 in each optical fiber 72 is aligned with the optical axis of the core of the corresponding optical waveguide 64.

The optical fiber array 70 projects further in the first direction X1 from the end surface 30A of the wiring structure 30 in the first direction X1. The optical fiber array 70 is arranged so that the end surface of the optical fiber array 70 in the first opposite direction X2 contacts the end surface of the optical waveguide device 60 in the first direction X1. In this state, a gap may form between the optical fiber array 70 and the optical waveguide device 60.

The optical fiber array 70 is bonded by an optical adhesive 75 to the optical waveguide device 60. Each optical fiber 72 is, for example, optically coupled by the optical adhesive 75 to the corresponding optical waveguide 64 of the optical waveguide device 60. The optical adhesive 75, for example, fills the gap between the optical waveguide device 60 and the optical fiber array 70. The optical adhesive 75, which fills the gap between the optical waveguide device 60 and the optical fiber array 70, prevents air reflection and increases the coupling efficiency of the optical waveguides 64 and the optical fibers 72. The optical adhesive 75, for example, entirely covers the end surface of each optical fiber 72 in the first opposite direction X2. The optical adhesive 75, for example, entirely covers the end surface of each optical waveguide 64 in the first direction X1. The optical adhesive 75 may be, for example, of an ultraviolet curable type. The optical adhesive 75 may have a refractive index that is close to the refractive index of the core of each optical waveguide 64 or the refractive index of the core 73 of each optical fiber 72.

As illustrated in FIG. 1, the optical fiber arrays 70 are mounted on the parts of the core substrate 20 exposed by the notches 40. Each optical fiber array 70 is fixed to, for example, the bottom surface of the corresponding recess 41. The housing 71 of the optical fiber array 70 is, for example, adhered by the adhesive agent 76 to the bottom surface of the recess 41. The adhesive agent 76 bonds the lower surface of the housing 71 to the core substrate 20, which defines the bottom surface of the recess 41. The adhesive agent 76 may be, for example, of an ultraviolet curing type of a thermal curing type.

### Structure of Electronic Component 80

The electronic component 80 includes electrode pads 81 formed on one surface (in this case, lower surface) of the electronic component 80. The electronic component 80 is mounted on the upper surface of the wiring substrate 11. The electronic component 80 is, for example, flip-chip mounted on the upper surface of the wiring structure 30 of the wiring substrate 11. The electrode pads 81 of the electronic component 80 are electrically connected by a bonding member 82 to the connection pads P2 of the wiring substrate 11. Thus, the electronic component 80 is electrically connected by the electrode pads 81 and the bonding member 82 to the wiring layer 35 of the wiring substrate 11. The electronic component 80 is, for example, electrically connected by the wiring layers 31, 33, and 35 of the wiring substrate 11 and the like to the optical waveguide devices 60. A single electronic component 80 may be provided for each optical waveguide device 60. Alternatively, a single electronic component 80 may be provided for multiple optical waveguide devices 60.

The electronic component 80 may be, for example, an IC chip such as a driver that drives the optical elements 63 (refer to FIG. 2) of each optical waveguide device 60. Further, the electronic component 80 may be, for example, an IC chip that incorporates a digital signal processor (DSP) for processing optical output signals from the optical elements 63 (refer to FIG. 2) of each optical waveguide device 60, or an IC chip that incorporates an amplifier for amplifying the optical output signals.

The electrode pads 81 respectively face the connection pads P2. Each electrode pad 81 is, for example, cylindrical and projects downward from the lower surface of the electronic component 80. Each electrode pad 81 is, for example, a metal post. The electrode pads 81 may be formed from, for example, copper or a copper alloy.

The bonding member 82 may include, for example, gold bumps or solder bumps. The material of the solder bumps may be an alloy including Pb, an alloy of Sn and Au, an alloy of Sn and Cu, an alloy of Sn and Ag, or an alloy of Sn, Ag, and Cu.

### Method for Manufacturing Optical Module 10

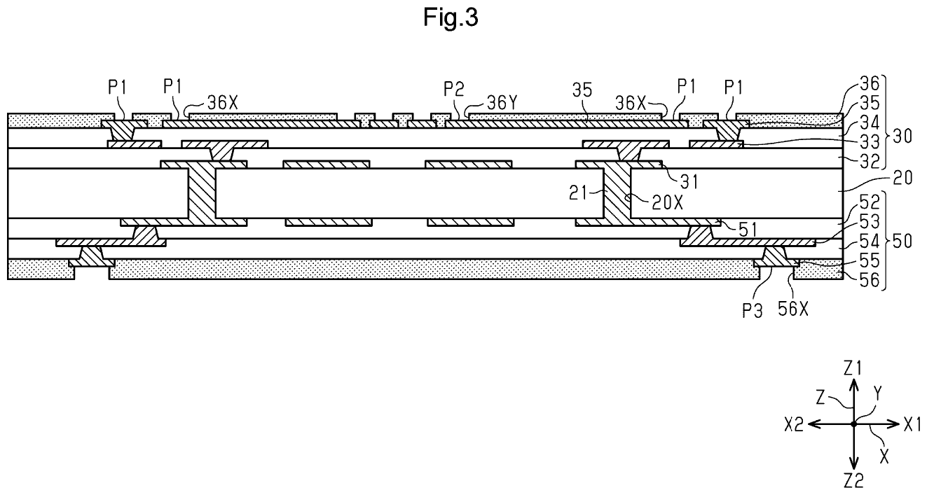

A method for manufacturing the optical module 10 will now be described with reference to FIGS. 3 to 6. To simplify illustration, elements that will ultimately become the final elements of the optical module 10 are given the same reference characters as the final elements.

First, in the step illustrated in FIG. 3, a structural body is formed including the core substrate 20, the wiring structure 30 on the upper surface of the core substrate 20, and the wiring structure 50 on the lower surface of the core substrate 20. The structural body may be formed through a process that is known in the art. Thus, the process will not be described in detail.

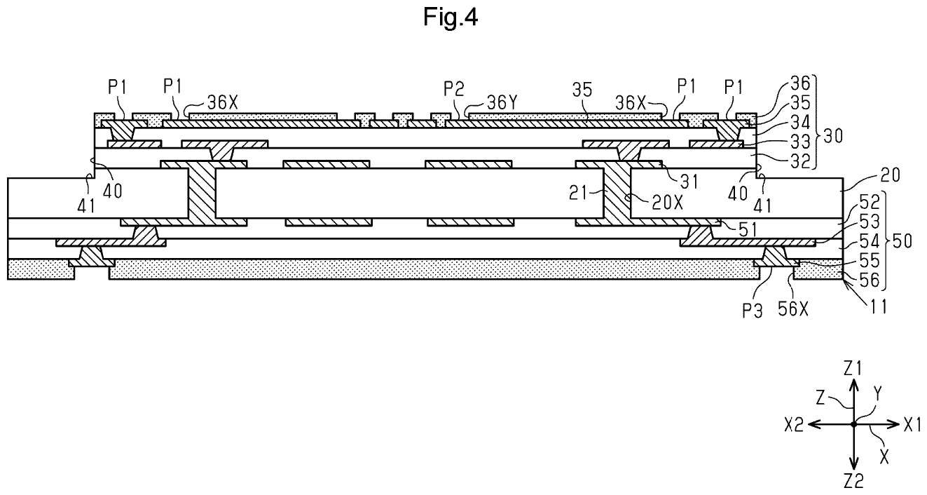

In the step illustrated in FIG. 4, the notches 40 are formed extending through the wiring structure 30 in the thickness direction and exposing parts of the core substrate 20. In the present embodiment, the formation of the notches 40 also forms the recesses 41, which are in communication with the notches 40. The bottom surface of each recess 41 is located downward from the upper surface of the core substrate 20. The notches 40 and the recesses 41 may be formed by, for example, machining the wiring structure 30 from the upper surface with a router. In the present embodiment, the core substrate 20 exposed by the notches 40 is machined from the upper surface of the core substrate 20 to form the recess 41 in communication with the notches 40. The wiring substrate 11 is manufactured through the steps described above.

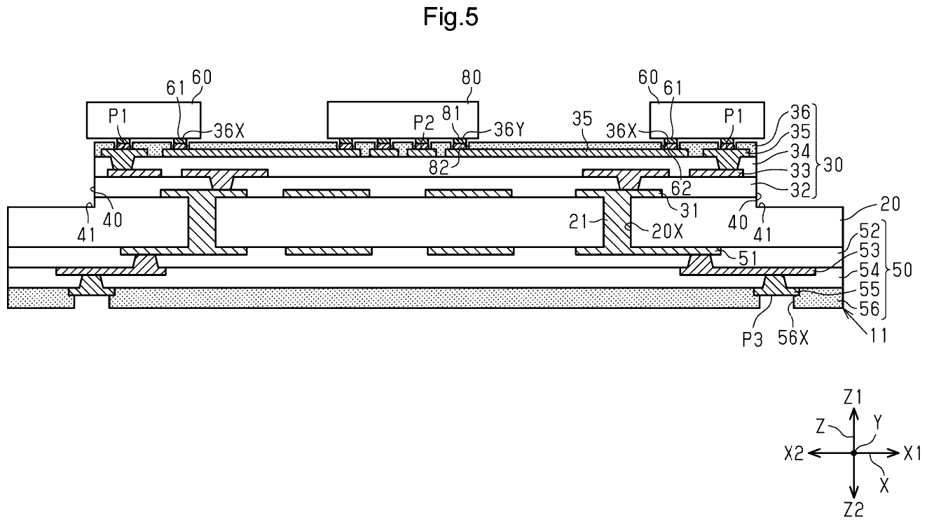

Then, in the step illustrated in FIG. 5, the optical waveguide devices 60 are mounted on the wiring substrate 11, and the electronic component 80 is mounted on the wiring substrate 11. In this step, the electrode pads 61 of the optical waveguide devices 60 are bonded by the bonding member 62 to the connection pads P1 of the wiring substrate 11. For example, when the bonding member 62 is a solder layer, the electrode pads 61 are aligned with the connection pads P1. Then, a reflow process is performed to melt the bonding member 62, which is a solder layer. This electrically connects the electrode pads 61 to the connection pads P1. Further, in this step, the electrode pads 81 of the electronic component 80 are bonded by the bonding member 82 to the connection pads P2 of the wiring substrate 11. For example, when the bonding member 82 is a solder layer, the electrode pads 81 are aligned with the connection pads P2. Then, a reflow process is performed to melt the bonding member 82. This electrically connects the electrode pads 81 and the connection pads P2. The optical waveguide devices 60 are arranged to partially overlap the corresponding notches 40 in plan view.

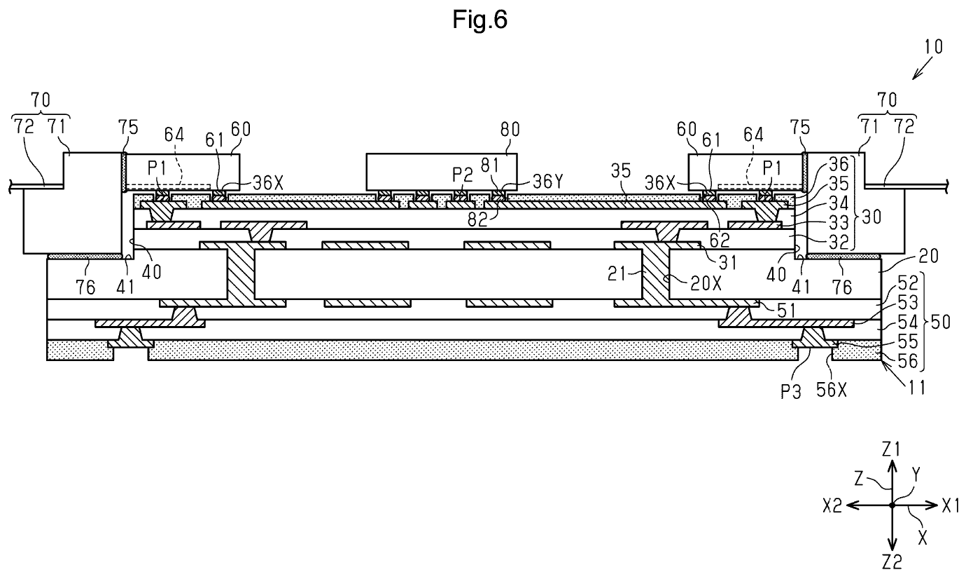

In the step illustrated in FIG. 6, the optical fiber arrays 70, in a state optically coupled to the optical waveguide devices 60, are mounted on the parts of the core substrate 20 exposed by the notches 40. The optical fiber arrays 70 are firstly aligned with the optical waveguide devices 60. That is, the optical fiber arrays 70 are positioned relative to the optical waveguide devices 60 so that the optical axis of each optical waveguide 64 is aligned with the optical axis of the corresponding optical fiber 72. Such positioning is performed through, for example, active alignment. By mounting the optical fiber arrays 70 on the parts of the core substrate 20 exposed by the notches 40, the optical axis of each optical fiber 72 is aligned with the optical axis of the corresponding optical waveguide 64 in the Z-axis direction. In other words, the depth of the recesses 41 is adjusted so that when the optical fiber arrays 70 are mounted on the parts of the core substrate 20 exposed by the notches 40, namely, on the bottom surfaces of the recesses 41, the optical axis of each optical fiber 72 is aligned with the optical axis of the corresponding optical waveguide 64 in the Z-axis direction.

Then, the optical waveguide devices 60 are bonded to the optical fiber arrays 70 with the optical adhesive 75. Further, the optical fiber arrays 70 are bonded to the bottom surfaces of the recesses 41 with the adhesive agent 76. For example, a dispenser or the like is used to apply the optical adhesive 75 in an uncured state between the optical waveguide devices 60 and the optical fiber arrays 70. A dispenser or the like is also used to apply the adhesive agent 76 in an uncured state between the optical fiber arrays 70 and the bottom surfaces of the recess 41. The optical adhesive 75 and the adhesive agent 76 are then irradiated with ultraviolet light and cured. This bonds the optical waveguide devices 60 and the optical fiber arrays 70 with the optical adhesive 75, and bonds the optical fiber arrays 70 to the bottom surfaces of the recesses 41 with the adhesive agent 76. The optical module 10 in accordance with the present embodiment is manufactured through the steps described above.

The present embodiment has the advantages described below.

(1) The optical module 10 includes the wiring substrate 11, the optical waveguide devices 60, which are mounted on the wiring substrate 11, and the optical fiber arrays 70, which are connected to the optical waveguide devices 60. The wiring substrate 11 includes the core substrate 20, the wiring structure 30, which is formed on the upper surface of the core substrate 20, and the notches 40, which extend through the wiring structure 30 in the thickness direction and expose parts of the core substrate 20. The optical waveguide devices 60 are mounted on the upper surface of the wiring structure 30 at positions proximate to the notches 40. The optical fiber arrays 70 are mounted on the parts of the core substrate 20 exposed by the notches 40.

In this structure, the optical fiber arrays 70 are connected to the optical waveguide devices 60 and fixed to the core substrate 20. Thus, the optical fiber arrays 70 are joined with the optical waveguide devices 60 and also joined with the core substrate 20. Compared with when only the optical waveguide devices 60 are joined with the optical fiber arrays 70, the optical fiber arrays 70 are joined with higher rigidity to the optical waveguide devices 60 and the core substrate 20. In other words, the optical fiber arrays 70, which are bonded to the core substrate 20, reinforce the strength of the bonding of the optical waveguide devices 60 and the optical fiber arrays 70. As a result, the coupling reliability of the optical waveguide devices 60 and the optical fiber arrays 70 is improved. For example, when an unexpected external force is applied to the optical fiber arrays 70, the optical waveguide devices 60 and the optical fiber arrays 70 will resist the external force and remain coupled.

(2) The recesses 41 are formed in the upper surface of the core substrate 20 at the parts exposed by the notches 40, and the optical fiber arrays 70 are fixed to the bottom surfaces of the recess 41. This structure allows the depth of the recesses 41 to be adjusted in order to facilitate positional adjustment of the optical axes of the optical fibers 72 in the Z-axis direction. Thus, adjustment of the depth of the recesses 41 in accordance with the thickness of the wiring structure 30, the optical waveguide device 60, and the optical fiber array 70 allows the optical axes of the optical fibers 72 to be positioned in the Z-axis direction. Accordingly, even when the wiring structure 30, the optical waveguide devices 60, and the optical fiber arrays 70 have varying thicknesses, the depth of the recesses 41 may be adjusted to align the optical axes of the optical fibers 72 with the optical axes of the optical waveguides 64 in the Z-axis direction.

(3) The end of the optical waveguide device 60 in the first direction X1 overlaps the corresponding notch 40 in plan view. In this structure, the end of the optical waveguide device 60 in the first direction X1 projects from the inner end surface of the notch 40 in the first direction X1. This allows the optical fiber array 70 to be arranged so that the end of the optical fiber array 70 in the first opposite direction X2 contacts the end of the optical waveguide device 60 in the first direction X1.

(4) The difference in the coefficient of thermal expansion between the core substrate 20 and the optical fiber arrays 70 is less than the difference in the coefficient of thermal expansion between the wiring structure 30 and the optical fiber arrays 70. In comparison with when the optical fiber arrays 70 are fixed to the wiring structure 30, the difference in the coefficient of thermal expansion is less between the parts to which the optical fiber arrays 70 are fixed (core substrate 20 in the present embodiment) and the optical fiber arrays 70. Thus, even when the optical module 10 is exposed to, for example, a high-temperature environment, the difference in the amount of thermal deformation will be limited between the core substrate 20 and the optical fiber arrays 70. This obviates optical axis displacement of the optical fibers 72 that would result from the difference in thermal deformation.

(5) The difference in the coefficient of thermal expansion between the core substrate 20 and the optical waveguide devices 60 is less than the difference in the coefficient of thermal expansion between the wiring structure 30 and the optical waveguide devices 60. This decreases the difference in the coefficient of thermal expansion of the core substrate 20, to which the optical fiber arrays 70 are fixed, from the coefficient of thermal expansion of the optical fiber arrays 70 and the coefficient of thermal expansion of the optical waveguide devices 60. Thus, even when the optical module 10 is exposed to, for example, a high-temperature environment, the difference in the amount of thermal deformation will be limited between the core substrate 20, the optical fiber arrays 70, and the optical waveguide devices 60. This obviates optical axis displacement of the optical fibers 72 and the optical waveguides 64 that would result from the difference in thermal deformation.

(6) The wiring structure 30 may include a recess, and the optical fiber array 70 may be fixed to the bottom surface of the recess. In this case, when the depth of the recess changes, the coefficient of thermal expansion may change at the part where the optical fiber array 70 is fixed. The wiring structure 30 is formed by stacking a number of members. Thus, in accordance with the depth of the recess, the member exposed by the recess will change, that is, the member acting as the part to which the optical fiber array 70 is fixed will change. Accordingly, when the depth of the recess changes, the coefficient of thermal expansion of the part to which the optical fiber array 70 is fixed will change.

In this respect, in the optical module 10 in accordance with the present embodiment, the core substrate 20 is configured by a single layer. That is, the core substrate 20 is configured by a single member. Thus, even when the depth of the recess 41 is changed, the coefficient of thermal expansion of the core substrate 20, which is the part to which the optical fiber array 70 is fixed, will vary subtly.

(7) The gap between each optical waveguide device 60 and the corresponding optical fiber array 70 is filled with the optical adhesive 75. Thus, even when a gap forms between the optical waveguide device 60 and the optical fiber array 70, air reflection will be prevented at the gap. This will increase the coupling efficiency of the optical waveguide device 60 and the optical fiber array 70.

(8) The optical fiber arrays 70 are adhered by the adhesive agent 76 to the core substrate 20. This firmly fixes the optical fiber arrays 70 to the core substrate 20.

### MODIFIED EXAMPLES

The above embodiments may be modified as described below. The above embodiments and the modified examples described below may be combined as long as there is no technical contradiction.

In the above embodiment, the part in the upper surface of the core substrate 20 exposed by each notch 40 entirely includes the recess 41. This, however, is not a limitation. For example, the recess 41 may be provided in only a portion of the part in the upper surface of the core substrate 20 exposed by each notch 40.

The depth of the recesses 41 in the above embodiment may be changed.

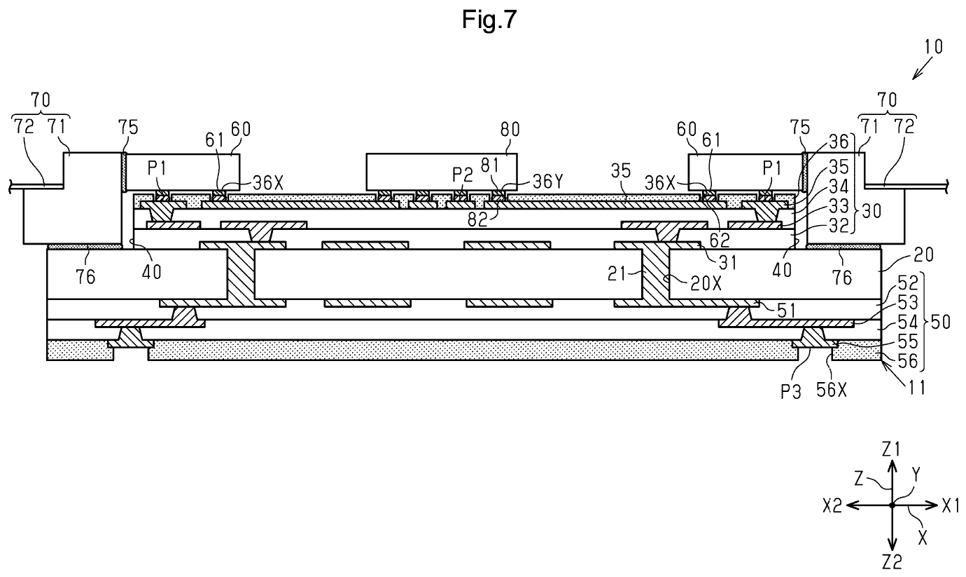

For example, as illustrated in FIG. 7, the recesses 41 may be omitted. In this case, the optical fiber arrays 70 are fixed to the parts in the upper surface of the core substrate 20 exposed by the notches 40. Further, the parts in the upper surface of the core substrate 20 exposed by the notches 40 are flush with the other parts in the upper surface of the core substrate 20.

In the above embodiment, each notch 40 extends over only part of the wiring structure 30 in the second direction Y1. For example, the notch 40 may extend over the entire length of the wiring structure 30 in the second direction Y1. For example, the notch 40 may extend over the entire periphery of the wiring structure 30. In this case, the peripheral portion of the core substrate 20 is entirely exposed by the notch 40.

Each optical fiber array 70 includes three optical fibers 72 in the above embodiment. However, there is no particular limitation to the number of optical fibers 72. The number of optical fibers 72 in the optical fiber array 70 may be one, two, four, or more.

In the optical module 10 of the above embodiment, the optical component connected to each optical waveguide device 60 is the optical fiber array 70. This, however, is not a limitation.

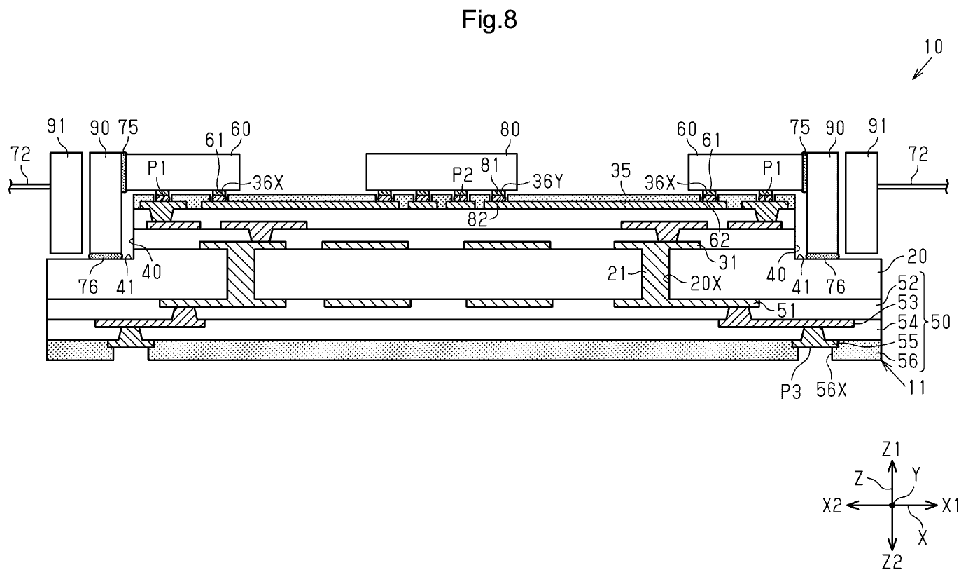

For example, as illustrated in FIG. 8, the optical component connected to each optical waveguide device 60 is an optical connector 90. The optical connector 90 is optically coupled to the optical waveguide device 60 and fixed to the part of the core substrate 20 exposed by the corresponding notch 40. For example, the optical connector 90 is bonded by the optical adhesive 75 to the optical waveguide device 60 and bonded by the adhesive agent 76 to the core substrate 20. The optical connector 90 is, for example, configured to be attached in a removable manner to a mating connector 91 including one or more optical fibers 72.

Instead of the optical fiber array 70 and the optical connector 90, the optical component connected to each optical waveguide device 60 may be, for example, a planar lightwave circuit.

Each optical waveguide device 60 in the above embodiment includes three optical waveguide 64. However, the optical waveguides 64 are not particularly limited in number. The number of the optical waveguides 64 may be one, two, four, or more.

Each optical waveguide device 60 includes three optical elements 63. However, the optical elements 63 are not particularly limited in number. The number of the optical elements 63 may be one, two, four, or more.

In each optical waveguide device 60 of the above embodiment, a single optical element 63 is provided for each optical waveguide 64. This, however, is not a limitation. For example, a single optical element 63 may be provided for a number of optical waveguides 64.

In the wiring structure 30 of the above embodiment, the wiring layers 31, 33, and 35 may be replaced by any number of layers and be laid out in any manner. Further, the insulation layers 32 and 34 may be replaced by any number of layers.

In the wiring structure 50 of the above embodiment, the wiring layers 51, 53, and 55 may be replaced by any number of layers and be laid out in any manner. Further, the insulation layers 52 and 54 may be replaced by any number of layers.

The wiring structure 50 of the above embodiment may be omitted.

In the wiring substrate 11 of the above embodiment, the solder resist layers 36 and 56 may be omitted.

In the optical module 10 of the present embodiment, the optical waveguide devices 60, the optical fiber arrays 70, and the electronic component 80 are not particularly limited in number.

### Clauses

This disclosure further encompasses the following embodiments.

1. A method for manufacturing an optical module, the method including:
forming a wiring substrate that includes a core substrate and a wiring structure formed on an upper surface of the core substrate;
forming a notch extending through the wiring structure and exposing a peripheral portion of the core substrate;
mounting an optical waveguide device on an upper surface of the wiring structure; and
coupling an optical component to the optical waveguide device and fixing the optical component to the peripheral portion of the core substrate exposed from the notch.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An optical module, comprising:
a wiring substrate; and
an optical waveguide device mounted on the wiring substrate, wherein
the wiring substrate includes
a core substrate,
a wiring structure located on an upper surface of the core substrate, and
a notch extending through the wiring structure in a thickness direction and exposing a peripheral portion of the core substrate, and
the optical waveguide device is mounted on an upper surface of the wiring structure at a position proximate to the notch.

2. The optical module according to claim 1, further comprising an optical component that is fixed to the peripheral portion of the core substrate exposed by the notch and is coupled to the optical waveguide device.

3. The optical module according to claim 1, wherein
the notch defines a step between the upper surface of the wiring structure and the upper surface of the core substrate, and
the optical waveguide device is mounted on the upper surface of the wiring structure so that a part of the optical waveguide device projects beyond a wall of the step into the notch in plan view.

4. The optical module according to claim 2, wherein the notch is sized to expose a part of the peripheral portion of the core substrate and receive the optical component on the part of the peripheral portion of the core substrate.

5. The optical module according to claim 2, wherein
the core substrate includes a recess in the upper surface of the core substrate exposed by the notch,
the recess includes a bottom surface that is defined by an upper surface of a thin portion of the core substrate that is reduced in thickness by the recess, and
the optical component is fixed to the bottom surface of the recess.

6. The optical module according to claim 2, wherein
an end surface of the wiring structure in a first direction is cut out in a first opposite direction that is opposite the first direction to define the notch,
the notch is open in the first direction, and
an end of the optical waveguide device in the first direction overlaps the notch in plan view.

7. The optical module according to claim 6, wherein the notch has a dimension that is greater than that of the optical component in a second direction that is orthogonal to the first direction in plan view.

8. The optical module according to claim 2, wherein a difference in coefficient of thermal expansion between the core substrate and the optical component is less than a difference in coefficient of thermal expansion between the wiring structure and the optical component.

9. The optical module according to claim 8, wherein a difference in coefficient of thermal expansion between the core substrate and the optical waveguide device is less than a difference in coefficient of thermal expansion between the wiring structure and the optical waveguide device.

10. The optical module according to claim 2, wherein the core substrate is configured by a single layer.

11. The optical module according to claim 2, further comprising:
an optical adhesive that bonds the optical waveguide device and the optical component; and
an adhesive agent that bonds the optical component and the core substrate,
wherein the optical adhesive fills a gap between the optical waveguide device and the optical component.
